(19) United States
(12) Patent Application Publication
(10) Pub. No.: US 2014/0291982 A1
(43) Pub. Date: Oct. 2, 2014

(54) PIPE COUPLING

(71) Applicant: SUPERIOR FIT, LLC, Davenport, OK (US)

(72) Inventors: Victor Orr, Davenport, OK (US); Gregory Bohl, Muenster, TX (US)

(73) Assignee: SUPERIOR FIT, LLC, Davenport, OK (US)

(21) Appl. No.: 13/853,861

(22) Filed: Mar. 29, 2013

(51) Int. Cl. F16L 33/22

(52) U.S. Cl. CPC F16L 33/22
USPC 285/257

(57) ABSTRACT

A plastic pipe to metal pipe coupling includes a metal pipe, a plastic pipe and a metal retaining collar. The metal pipe has an inner diameter, a first end, a second end and a barbed outer portion proximate to the second end. The plastic pipe has an inner diameter, a first end and a second end. A portion of the plastic pipe proximate to the first end is disposed around the barbed outer portion of the metal pipe. The metal retaining collar is disposed around the portion of the plastic pipe and compresses the portion of the plastic pipe onto the barbed outer portion of the metal pipe.

### CROSS-REFERENCE TO RELATED APPLICATIONS

Not Applicable.

### STATEMENT OF FEDERALLY FUNDED RESEARCH

Not Applicable.

### REFERENCE TO A SEQUENCE LISTING

Not Applicable.

### TECHNICAL FIELD OF THE INVENTION

The present invention relates in general to couplings for mechanically joining plastic pipes to metal pipes.

### BACKGROUND OF THE INVENTION

Without limiting the scope of the invention, mechanical joints between plastic pipes and metal pipes have long been plagued with installation and operational problems. For example, the plastic pipe can crack or break during the joining process. Moreover, the end of the plastic pipe may deform under pressure resulting in leaks. The differences between the expansion/contraction rates of the plastic pipe and metal pipe can also cause the joint to become loose resulting in leaks.

As a result, there is a need for a pipe coupling that is simple to install and does not degrade under normal operating conditions.

### SUMMARY OF THE INVENTION

The present invention provides a pipe coupling that is simple to install and does not degrade under normal operating conditions by “sandwiching” the end of the plastic pipe between a barbed portion of a metal pipe and a metal retaining collar.

More specifically, the present invention provides a plastic pipe to metal pipe coupling that includes a first metal pipe, a plastic pipe and a metal retaining collar. The first metal pipe has an inner diameter, a first end, a second end and a barbed outer portion proximate to the second end. The plastic pipe has an inner diameter, a first end and a second end. A portion of the plastic pipe proximate to the first end is disposed around the barbed outer portion of the first metal pipe. The metal retaining collar is disposed around the portion of the plastic pipe and compresses the portion of the plastic pipe onto the barbed outer portion of the first metal pipe.

In addition, the present invention provides a method for coupling a plastic pipe to a metal pipe. A first metal pipe having an inner diameter, an outer diameter, a first end, a second end and a barbed outer portion proximate to the second end is provided. A plastic pipe having an inner diameter, a first end and a second end is also provided. The inner diameter of the plastic pipe is approximately equal to the inner diameter or the outer diameter of the first metal pipe to provide a friction fit. The first end of the plastic pipe is pushed over the barbed outer portion of the first metal pipe. A metal retaining collar is pushed onto a portion of the plastic pipe proximate to the first end to compress the portion of the plastic pipe onto the barbed outer portion of the first metal pipe and couple the plastic pipe to the first metal pipe.

The present invention also provides a metal transition assembly and a method of making the metal transition assembly by attaching a second metal pipe, a flange and/or an elbow to the first metal pipe.

### BRIEF DESCRIPTION OF THE DRAWINGS

For a more complete understanding of the features and advantages of the present invention, reference is now made to the detailed description of the invention along with the accompanying figures and in which:

FIGS. 1A and 1B are a side view and cross-sectional view of a plastic pipe to a metal pipe coupling in accordance with one embodiment of the present invention;

FIGS. 2A, 2B and 2C are a side view, detail view and isometric view of the metal pipe in accordance with one embodiment of the present invention;

FIGS. 3A and 3B are a side view and isometric view of the plastic to metal pipe transition in accordance with one embodiment of the present invention; and

FIG. 4 is a flow chart of a method to couple a plastic pipe to a metal pipe in accordance with one embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an,” and “the” are not intended to refer to only a singular entity, but include the general class of which a specific example may be used for illustration. The terminology herein is used to describe specific embodiments of the invention, but their usage does not delimit the invention, except as outlined in the claims.

The present invention provides a pipe coupling that is simple to install and does not degrade under normal operating conditions by “sandwiching” the end of the plastic pipe between a barbed portion of a metal pipe and a metal retaining collar.

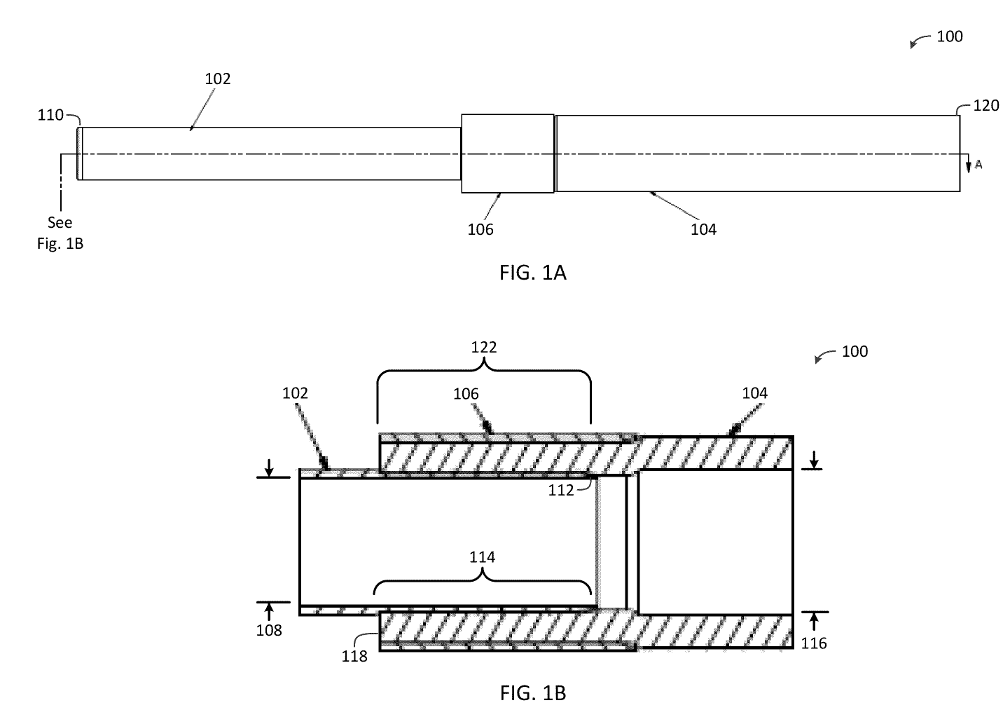

Now referring to FIGS. 1A and 1B, a side view and cross-sectional view of a plastic pipe to a metal pipe coupling 100 in accordance with one embodiment of the present invention is shown. The coupling 100 includes a first metal pipe 102 (also referred to as a transition coupon), a plastic pipe 104 and a metal retaining collar 106 (e.g., steel, etc.). The first metal pipe 102 (e.g., steel, etc.) has an inner diameter 108, a first end 110, a second end 112 and a barbed outer portion 114 proximate to the second end 112. The plastic pipe 104 (e.g., polyethylene, etc.) has an inner diameter 116, a first end 118 and a second end 120. A portion or section 122 of the plastic pipe 104 proximate to the first end 118 is disposed around the barbed outer portion 114 of the first metal pipe 102. The metal retaining collar 106 is disposed around the portion or section 122 of the plastic pipe 104 and compresses the portion or section 122 of the plastic pipe 104 onto the barbed outer portion 114 of the first metal pipe 102.

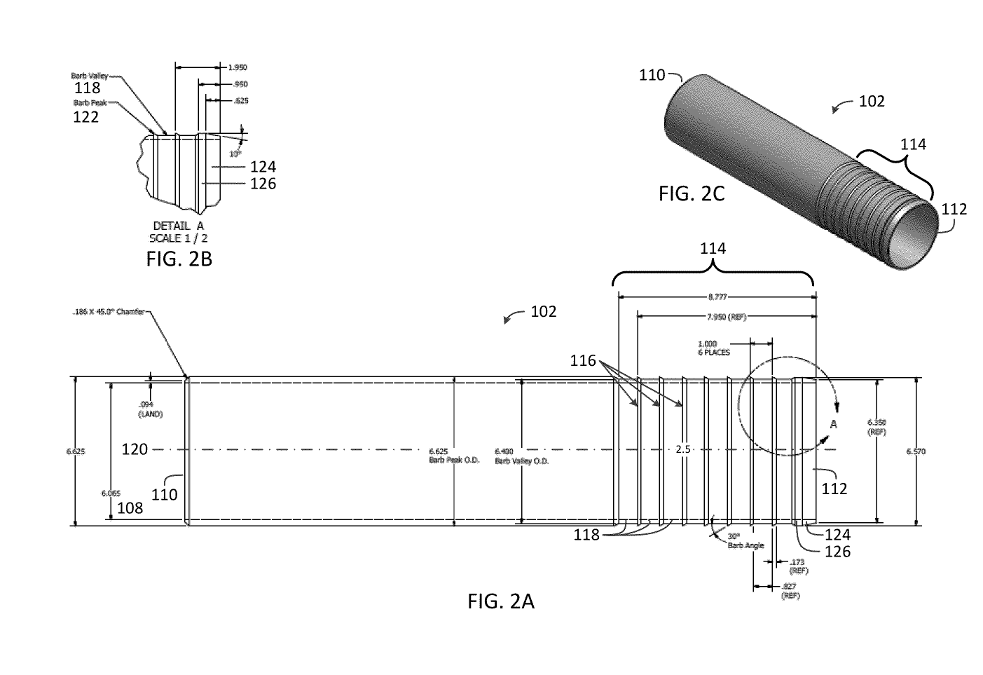

A slight friction fit should exist between an interior of the plastic pipe 104 and the exterior of the barbed outer portion 114 of the first metal pipe 102. Typically a force of approximately 0 to 10 pounds of force is desirable to push the plastic pipe 104 over the barbed outer portion 114 of the metal pipe 102. In some cases, it may be necessary to flare or compress a portion 122 of the plastic pipe 104 proximate to the first end 118 to provide a slight friction fit between the interior of the plastic pipe 104 and the exterior of the barbed outer portion 114 of the first metal pipe 102. Note also that a sealant (not shown) can be disposed between the barbed outer portion 114 of the first metal pipe 102 and the interior of the plastic pipe 104. The barbed outer portion 114 of the first metal pipe 102 is preferably, but not required to be, completely disposed within the plastic pipe 104. The barbed outer portion 114 is described in more detail below in reference to FIGS. 2A, 2B and 2C. Similarly, the metal retaining collar 106 is preferably, but not required to, extend beyond the second end 112 of the first metal pipe 102. Finally, one or more protective coatings (not shown) can be disposed on an interior or an exterior of all or part of the coupling 100.

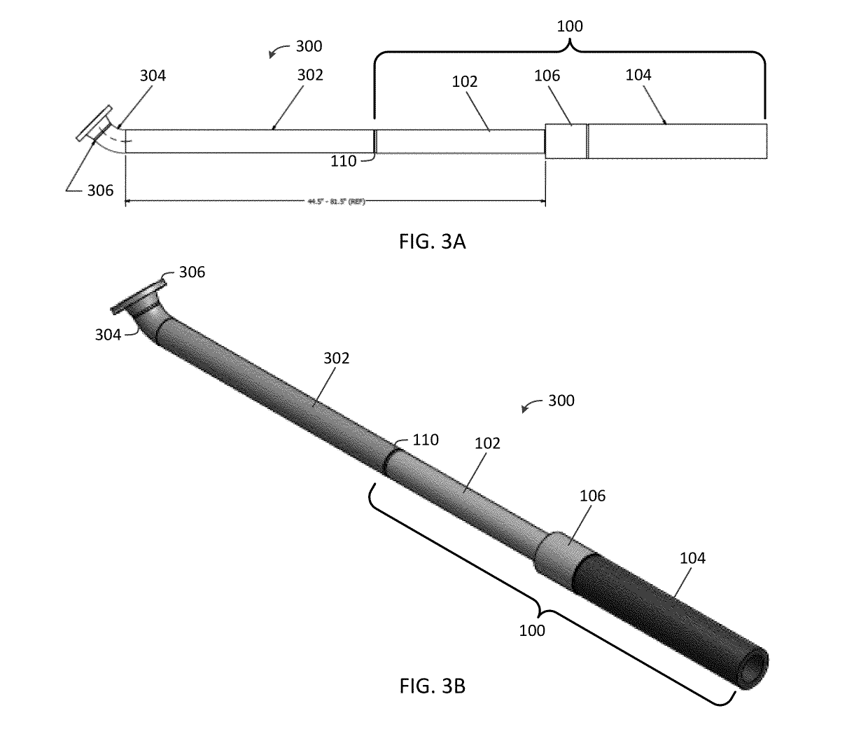

As will be described below in FIGS. 3A and 3B, another embodiment of the present invention provides a metal transition assembly 300 that includes a second metal pipe 302, a flange 306 and/or an elbow 304 attached to the first metal pipe 102. Other components can be attached to the first metal pipe 102 to provide additional embodiments of the present invention.

Referring now to FIGS. 2A, 2B and 2C, a side view, detail view and isometric view of the first metal pipe 102 in accordance with one embodiment of the present invention are shown. The first metal pipe 102, commonly referred to as a transition coupon, has an inner diameter 108, a first end 110, a second end 112 and a barbed outer portion 114 proximate to the second end 112. The barbed outer portion 114 has a length of approximately 3 to 12 inches and includes two or more barbs 116 having a valley 118 disposed there between. Each barb 116 extends around a circumference of the first metal pipe 102 substantially perpendicular to a longitudinal axis 120 of the first metal pipe 102. Each of the barbs extends outward from the valley 118 at an angle of approximately 20 to 70 degrees (barb angle) to a barb peak 122. Each of the barbs 116 is spaced approximately 0.5 to 1.5 inches from one another. In addition, the barbed outer portion 114 also includes a ramp 124 at the second end 112 of the first metal pipe 102 having an angle of approximately 5 to 30 degrees, and a substantially flat portion 126 adjacent to the ramp 124. Note that the present invention is not limited to the dimensions, angles, number of barbs 116, shape of the barbs 116 or spacing between the barbs 116 described above or shown in FIGS. 2A-2C.

Now referring to FIGS. 3A and 3B, a side view and isometric view of the plastic to a metal pipe transition 300 in accordance with one embodiment of the present invention are shown. The metal pipe transition 300 includes the first metal pipe 102, the plastic pipe 104 and the metal retaining collar 106 as described above. In addition, the metal pipe transition 300 also includes a second metal pipe 302 attached to the first end 110 of the first metal pipe 102, and a flange 306 attached to the second metal pipe 302. In the example shown in FIGS. 3A and 3B, an elbow 304 is attached between the second metal pipe 302 and the flange 306. The elbow 304 can be of any degree (e.g., 45 degrees, 90 degrees, etc.) and radius (e.g., short, long, etc.) as is required by the installation and operation specifications. The metal pipe transition 300 may also include one or more internal or external protective coatings (not shown).

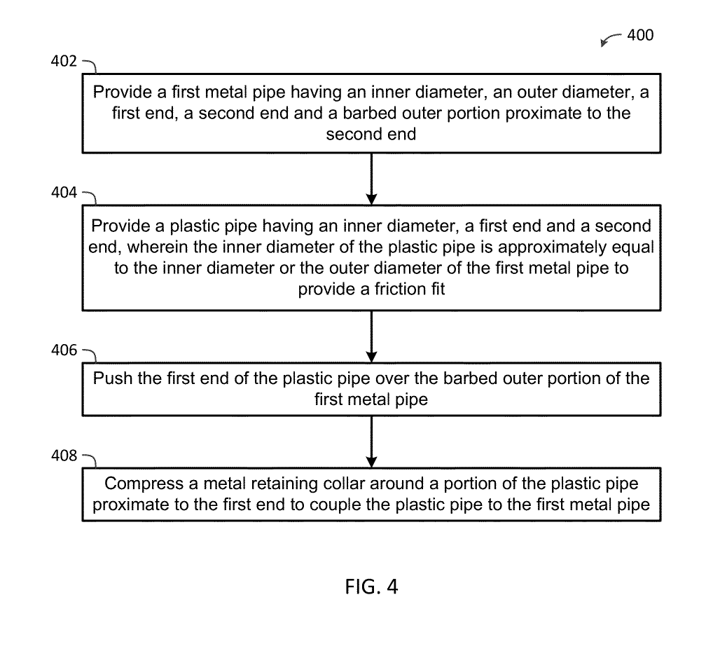

Referring now to FIG. 4, a flow chart of a method 400 to couple a plastic pipe 104 to a first metal pipe 102 in accordance with one embodiment of the present invention is shown. A first metal pipe having an inner diameter, an outer diameter, a first end, a second end and a barbed outer portion proximate to the second end is provided in block 402. A plastic pipe having an inner diameter, a first end and a second end is provided in block 404. The inner diameter of the plastic pipe is approximately equal to the inner diameter or the outer diameter of the first metal pipe to provide a friction fit. The portion of the plastic pipe proximate to the first end is pushed over the barbed outer portion of the first metal pipe in block 406. A metal retaining collar is pushed onto a portion of the plastic pipe proximate to the first end to compress the portion of the plastic pipe onto the barbed outer portion of the first metal pipe and couple the plastic pipe to the first metal pipe in block 408.

As previously described, a portion of the plastic pipe proximate to the first end may be flared or compressed to provide the friction fit between an interior of the plastic pipe and the barbed outer portion of the first metal pipe. Other steps may include machining the second end of the first metal pipe to form the barbed outer portion, applying a sealant on the barbed outer portion of the first metal pipe and an inner portion of the plastic pipe proximate to the first end, or applying one or more protective coatings on an interior or an exterior of all or part of the coupling. Additional steps to provide the plastic to a metal pipe transition may include attaching a second metal pipe to the first metal pipe, attaching a flange to the second metal pipe, and/or attaching an elbow between the second metal pipe and the flange.

A non-limiting example of a transition assembly process will now be described. One end of a polyethylene pipe is flared or compressed (based on diameter and compression ratios) for a slight friction fit (between zero and ten pounds of force) on the coupon barbed end. Next the flared or compressed end of the polyethylene pipe is then pushed onto (over) the coupon barbed end up to the shoulder of the last barb. This creates an overlap where the polyethylene inner wall is in contact with the coupon exterior wall throughout the barbed section of the coupon. Lastly, a steel compression collar is pressed onto the assembly and covers the overlapped section where the polyethylene is in contact with the coupon barbed end. This creates a three layer cross section of pipe throughout the length of the collar. The coupon is the inner layer, the polyethylene is the middle layer, and the compression collar is the outermost layer.

The steel collar is preferably pressed on the assembly where the collar extends up to the first barb but not past the last barb of the coupon to create 100% overlap or coverage of the coupon barbs with the steel compression collar. Note that the polyethylene pipe must be compressed onto the steel coupon barbs to seal the steel-to-polyethylene joint of the transition. The compression is achieved and maintained when the steel compression ring is pressed onto the transition assembly. The minimum compression required for a seal is 3% of the polyethylene cross sectional wall thickness regardless of the polyethylene grade or class. There is no maximum; however, compression above 45% has been observed to be unmanageable in certain circumstances.

It may be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications, patents and patent applications mentioned in the specification are indicative of the level of skill of those skilled in the art to which this invention pertains. All publications, patents and patent applications are herein incorporated by reference to the same extent as if each individual publication, patent or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it may be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A plastic pipe to metal pipe coupling comprising:
a first metal pipe having an inner diameter, a first end, a second end and a barbed outer portion proximate to the second end;
a plastic pipe having an inner diameter, a first end and a second end, wherein a portion of the plastic pipe proximate to the first end is disposed around the barbed outer portion of the first metal pipe; and
a metal retaining collar disposed around the portion of the plastic pipe proximate to the first end that compresses the portion of the plastic pipe onto the barbed outer portion of the first metal pipe.

2. The coupling as recited in claim 1, wherein the portion of the plastic pipe proximate to the first end is flared or compressed to provide a friction fit between an interior of the plastic pipe and the exterior of the barbed outer portion of the first metal pipe.

3. The coupling as recited in claim 1, wherein the barbed outer portion of the first metal pipe is completely disposed within the plastic pipe.

4. The coupling as recited in claim 1, further comprising a sealant disposed between the barbed outer portion of the first metal pipe and an inner portion of the plastic pipe proximate to the first end.

5. The coupling as recited in claim 1, wherein the metal retaining collar extends beyond the second end of the first metal pipe.

6. The coupling as recited in claim 1, wherein the barbed outer portion of the first metal pipe comprises two or more barbs having a valley disposed there between, each barb extending around a circumference of the first metal pipe substantially perpendicular to a longitudinal axis of the first metal pipe.

7. The coupling as recited in claim 6, wherein each of the barbs extends outward from the valley at an angle of approximately 20 to 70 degrees.

8. The coupling as recited in claim 6, wherein each of the barbs is spaced approximately 0.5 to 1.5 inches from one another.

9. The coupling as recited in claim 1, wherein the barbed outer portion of the first metal pipe comprises a ramp at the second end of the first metal pipe having an angle of approximately 5 to 30 degrees.

10. The coupling as recited in claim 9, further comprising a substantially flat portion adjacent to the ramp.

11. The coupling as recited in claim 1, wherein the barbed outer portion of the first metal pipe has a length of approximately 3 to 12 inches.

12. The coupling as recited in claim 1, wherein the plastic pipe comprises a polyethylene pipe and the first metal pipe comprises a steel pipe.

13. The coupling as recited in claim 1, further comprising:
a second metal pipe attached to the first metal pipe; and
a flange attached to the second metal pipe.

14. The coupling as recited in claim 13, further comprising an elbow attached between the second metal pipe and the flange.

15. The coupling as recited in claim 1, further comprising one or more protective coatings disposed on an interior or an exterior of all or part of the coupling.

16. A method for coupling a plastic pipe to a metal pipe comprising the steps of:
providing a first metal pipe having an inner diameter, an outer diameter, a first end, a second end and a barbed outer portion proximate to the second end;
providing a plastic pipe having an inner diameter, a first end and a second end, wherein the inner diameter of the plastic pipe is approximately equal to the inner diameter or the outer diameter of the first metal pipe to provide a friction fit;
pushing the first end of the plastic pipe over the barbed outer portion of the first metal pipe; and
pushing a metal retaining collar onto a portion of the plastic pipe proximate to the first end to compress the portion of the plastic pipe onto the barbed outer portion of the first metal pipe and couple the plastic pipe to the first metal pipe.

17. The method as recited in claim 16, further comprising the step of flaring or compressing a portion of the plastic pipe proximate to the first end to provide the friction fit between an interior of the plastic pipe and the barbed outer portion of the first metal pipe.

18. The method as recited in claim 16, further comprising the step of machining the second end of the first metal pipe to form the barbed outer portion.

19. The method as recited in claim 16, further comprising the step of applying a sealant on the barbed outer portion of the first metal pipe and an inner portion of the plastic pipe proximate to the first end.

20. The method as recited in claim 16, wherein a minimum compression applied to the metal retaining collar is greater than or equal three percent of a cross sectional wall thickness of the plastic pipe.

21. The method as recited in claim 16, wherein a force required to push the first end of the plastic pipe over the barbed outer portion of the first metal pipe is approximately 0 to 10 pounds of force.

22. The method as recited in claim 16, wherein barbed outer portion of the first metal pipe is completely disposed within the plastic pipe.

23. The method as recited in claim 16, wherein the metal retaining collar extends beyond the second end of the first metal pipe.

24. The method as recited in claim 16, wherein the barbed outer portion of the first metal pipe comprises two or more barbs having a valley disposed there between, each barb extending around a circumference of the first metal pipe substantially perpendicular to a longitudinal axis of the first metal pipe.

25. The method as recited in claim 24, wherein each of the barbs extends outward from the valley at an angle of approximately 20 to 70 degrees.

26. The method as recited in claim 24, wherein each of the barbs is spaced approximately 0.5 to 1.5 inches from one another.

27. The method as recited in claim 16, wherein the barbed outer portion of the first metal pipe comprises a ramp at the second end of the first metal pipe having an angle of approximately 5 to 30 degrees.

28. The method as recited in claim 27, further comprising a substantially flat portion adjacent to the ramp.

29. The method as recited in claim 16, wherein the barbed outer portion of the first metal pipe has a length of approximately 3 to 12 inches.

30. The method as recited in claim 16, wherein the plastic pipe comprises a polyethylene pipe and the first metal pipe comprises a steel pipe.

31. The method as recited in claim 16, further comprising the steps of:
attaching a second metal pipe to the first metal pipe; and
attaching a flange to the second metal pipe.

32. The method as recited in claim 31, further comprising the step of attaching an elbow between the second metal pipe and the flange.

33. The method as recited in claim 16, further comprising the step of applying one or more protective coatings on an interior or an exterior of all or part of the coupling.
